(19) United States
(12) Patent Application Publication
(10) Pub. No.: US 2016/0334941 A1
(43) Pub. Date: Nov. 17, 2016

(54) Method and Device for Optical Handwriting Recognition

(71) Applicant: Futurewei Technologies, Inc., Plano, TX (US)

(72) Inventors: Navid Nader, San Diego, CA (US); Robert McCarthy, Escondido, CA (US); Julia Wang, San Diego, CA (US)

(21) Appl. No.: 14/710,454

(22) Filed: May 12, 2015

(51) Int. Cl. G06F 3/042; G06F 3/01; G06F 3/0488; G06K 9/00

(52) U.S. Cl. CPC G06F 3/0426; G06K 9/00355; G06F 3/017; G06F 3/04883

(57) ABSTRACT

A method and a system for virtual handwriting recognition are disclosed. In an embodiment the method includes optically capturing a finger gesture by the camera unit of a computing device and transforming the finger gesture into a digital indicia by a processing unit of the computing device. The method further includes comparing the digital indicia with a stored indicia by the processing unit, wherein the stored indicia is stored in a memory unit of the computing device and displaying the digital indicia on a display of the computing device.

### TECHNICAL FIELD

The present invention relates to a method and device for optically identifying and tracking gestures or trajectories made by a user, or more particularly, a method and device for optical recognizing virtual handwriting gestures.

### BACKGROUND

There is a wide variety of data input options for computing devices. For example, letters or numbers can be entered into the computing device through a keypad, through writing with a pen on a digitizer pad, or through handwriting on a screen of the computing device.

### SUMMARY

In accordance with an embodiment of the present invention, a method for recognizing virtual handwriting comprises optically capturing a finger gesture by a camera unit of a computing device and transforming the finger gesture into a digital indicia by a processing unit of the computing device. The method further comprises comparing the digital indicia with a stored indicia by the processing unit of the computing device, wherein the stored indicia is stored in a memory unit of the computing device and displaying the digital indicia on a display of the computing device.

In accordance with an embodiment of the present invention, a computing device comprises a processing unit and a computer-readable storage medium storing a program to be executed by the processing unit, the program including instructions for: optically receiving an indicia gestured by a finger of a user in front of a camera unit of the computer device, transforming the optical indicia into a digital indicia, comparing the digital indicia to a stored digital indicia and displaying the digital indicia when the digital indicia matches the stored indicia.

In accordance with an embodiment of the present invention, a computing device comprises a camera unit configured to receive optical indicia data provided by a virtual handwriting gesture of a user, a processing unit operatively connected to the camera unit, the processing unit configured to transform the optical indicia data into digital indicia data and compare the digital indicia data with stored digital indicia data, wherein the stored digital indicia data are stored in a memory unit, the memory unit operatively connected to the processing unit, and a display operatively connected to the processing unit, the display configured to display the digital indicia data when the digital indicia data match the stored indicia data.

In accordance with an embodiment of the present invention, a non-transitory computer readable medium that stores instructions to be executed by a computing device, the instructions comprising optically capturing a finger gesture by a camera unit of the computing device, transforming the finger gesture into a digital indicia by a processing unit of the computing device, comparing the digital indicia with a stored indicia by the processing unit, wherein the stored indicia is stored in a memory unit of the computing device and displaying the digital indicia on a display of the computing device.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an handwriting gesture recognition process according to an embodiment of the invention;

FIG. 2 shows a computing device according to an embodiment of the invention;

FIG. 3a shows a conceptual implementation of how a gestured letter is read into a hand held device according to an embodiment; and

FIG. 3b shows a conceptual implementation of how a gestured character is read into a hand held device according to an embodiment.

### DETAILED DESCRIPTION OF ILLUSTRATIVE EMBODIMENTS

Hand held devices typically have only a limited number of preloaded keyboards. If a user has to edit a text document and switch between indicia such as letters, numbers, symbols, and characters located in different keyboards, the user has to switch back and forth between these keyboards which makes it burdensome and time consuming to input the indicia sequence into a hand held device. Moreover, editing documents on small hand held devices can be burdensome for some users (e.g., elderly users) because keys or buttons to enter text or numbers may be too small for these users.

Embodiments of the present invention provide a system and method for optically detecting and tracking finger gestures. For example, a computing device may track a user's finger performing gestures or trajectories over a surface in front of a camera of a computing device. Embodiments of the invention may recognize the finger or fingernail characteristics such as the cuticle shape or contrast between the cuticle shape and adjacent finger areas. An advantage of this method is that the tracked fingernail provides very accurate understanding of virtual handwriting gestures.

Embodiments of the invention provide indicia recognition without factory predefined stored indicia. The user is free to define any indicia. The user can virtually gesture all indicia in front of a camera and a gesture recognition algorithm converts these gestures into digital indicia displaying them on the display or screen of the computing device. The limitless indicia recognition has the advantage that the user does not need to switch between different keyboards looking for different symbols, letters or numbers. It further provides for a quicker entry of indicia into the computing device when various forms of text and graphics are used. Further, embodiments of the inventive method may prevent erroneous key selection or mistyping on a keyboard by elderly people or people with large fingers. Another advantage is that the user may edit or change documents by using only a computing device and a finger.

Embodiments of the inventions further provide indicia intake performed without a stencil, writing pad, or additional accessories which provides the additional advantage that these accessories cannot be lost or damaged.

Embodiments of the invention may not provide a wireless link between the user's finger and the computing device and may not provide a dedicated text entry area on the computing device. The intake may be established by an optical link in the visible light spectrum between 390 nm and 700 nm, for example.

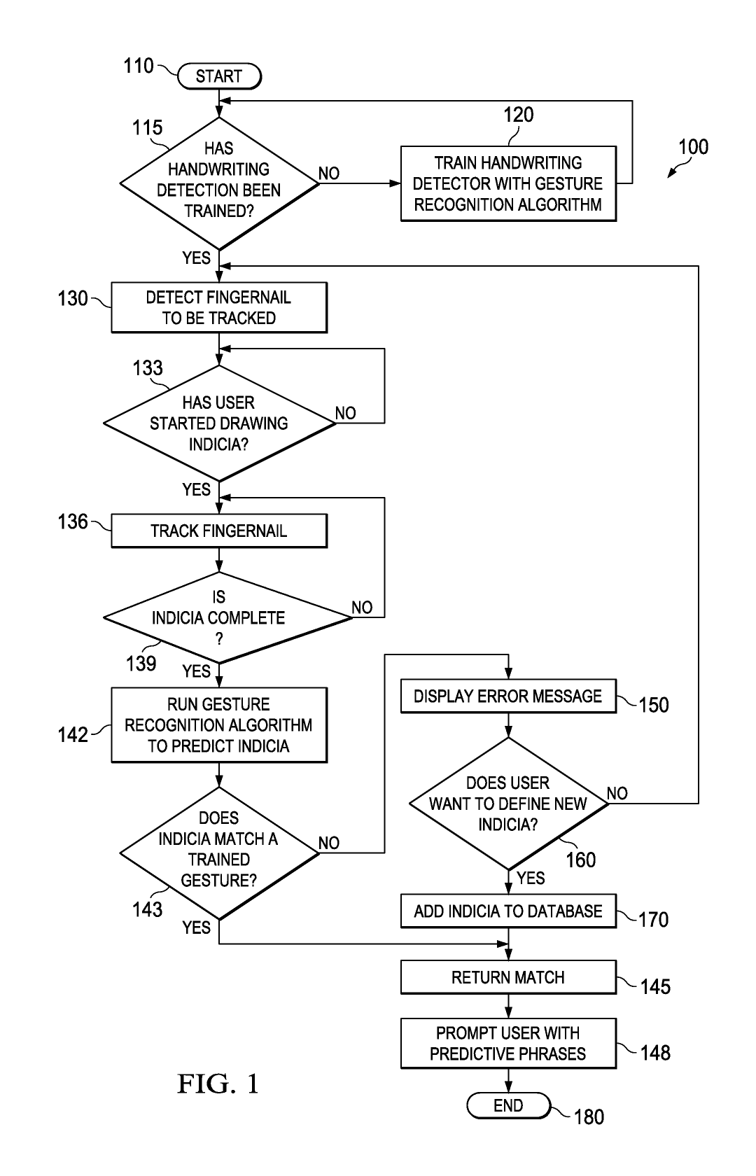

FIG. 1 shows a logical flow diagram for an optical gesture recognition process 100, in particular, a virtual handwriting recognition process. The flowchart 100 includes a start block, one or more decision blocks, one or more processing blocks, and an end block.

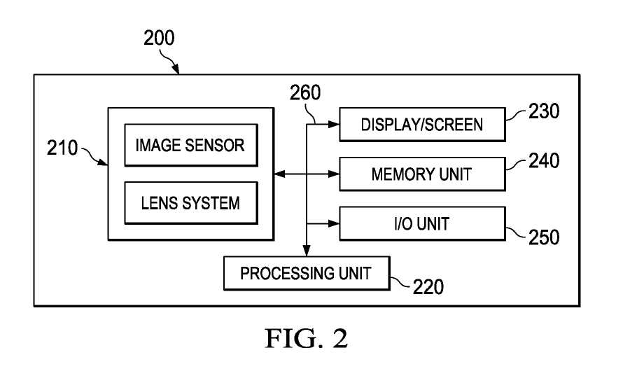

The process 100 begins at start block 110 when the computing device such as a hand held device is powered on. The hand held device may be a mobile phone, a tablet computer, a personal digital assistant (PDA), or another mobile or wireless device. An embodiment of the computing device may be shown in FIG. 2. The computing device 200 (e.g., a hand held device) may comprise a camera unit 210, a processing unit 220, a display or screen 230 a memory unit 240 and an I/O unit 250. The processing unit 220 is operatively connected to the camera unit 210 via a communication infrastructure 260. The processing unit 220 is further operatively connected to the memory unit 240, to the display or screen 230 and to the I/O unit 250. The computing device 200 may further include a network interface (not shown) such as a wireline or wireless interface. The wireline interface may be configured to receive data via a DSL protocol or Ethernet protocol. The wireless interface may be configured to receive data according to the 3G or LTE protocol. The network interface is also operatively connected via the communication infrastructure 260 to the processing unit 220.

The camera unit 210 may be a back facing camera unit. In this context back facing means that the camera unit 210 is located on another surface than the display or screen 230 of the computing device. Alternatively, the camera unit is monitoring an area which is different than the area the display 230 is displaying its features to. The camera unit 210 may comprise an image sensor and a lens system. The image sensor may be a chard coupled device (CCD) or a CMOS device. The image sensor is configured to receive and process signals in the visible light spectrum and may be configured to transform and process the received optical signals in the visible light spectrum into digital signals.

The memory unit 240 may be a volatile or non-volatile memory. For example, the volatile memory may be a SRAM, a DRAM or another volatile RAM. The non-volatile memory may be a programmable read only memory (PROM), flash memory, a MRAM, a FRAM, a PCRAM, or other non-volatile RAM.

The I/O unit 250 may be hardware a key pad or keyboard. Alternatively, the I/O unit 250 may be a key pad or keyboard displayed in a graphical user interface (GUI) of the display 230.

The processing unit 220 may process computer programs or other code or instructions stored in the memory unit 240. The computer programs, when executed, enable the computing device 200 to perform the optical gesture recognition process (e.g., virtual handwriting recognition process) according to embodiments described herein. In some embodiments the computer program product (e.g., software) is loadable into the computing device via the network interface, for example.

In some embodiments the computing device 200 may be a lap top computer or a desk top computer with an external camera unit the external camera unit being positioned such that it is capable of capturing the virtual handwriting of the user.

At decision block 115, a determination is made whether the hand held device has been trained. If the hand held device has been trained, processing advances to processing block 130. If the hand held device has not been trained, the processing advances to processing block 120.

At processing block 120 the hand held device is trained. For example, the hand held device may be trained when it is powered on or set up at the first time. The training of the device may require 5 to 10 minutes. The device may be trained by adding indicia such as text or graphics, character, letters, symbols, or numbers to the memory unit. For example, the user can gesture in front of the camera unit in order to provide indicia in digital format displayed on the display or screen of the hand held device. The user can train the hand held device with any indicia. For example, the user can train the device by gesturing or virtually writing the 26 letters of the English alphabet, the 33 letters of the Cyrillic alphabet, the 24 letters of the Greek alphabet, and/or the 28 letters of the Arabic alphabet. In alternative embodiments, the user can program the hand held device with the about 2,000 Chinese characters (for basic Chinese or 10,000 characters for a more sophisticated Chinese). The user can teach the device Korean characters, Japanese characters, or Indian letters. Letters or characters of other languages (such as Armenian, etc.) can be programmed too. The user may train the hand held device Latin numbers or other numbers. In yet other embodiments, the user may program the device with any graphic, logo or symbol, complicated or not.

The user may virtually handwrite or gesture the indicia with the finger on any surface in front of the camera unit such as a table top, a paper, a wall, etc. In some embodiments, the user may enter these indicia through a graphical user interface of the display by writing the indicia on screen and enter the indicia via the interface. The indicia may be stored in digital form in the memory unit of the hand held device.

When the hand held device is trained and programmed with the indicia, the process returns to decision block 115. Decision block 115 decides whether the hand held device has been trained and moves to processing block 130.

At block 130 the camera unit of the hand held device may be activated so that it can detect and capture the fingernail to be tracked. The camera unit may be activated by pressing or selecting a key or a combination of keys or buttons at the I/O unit. The keys or buttons may be selected via a graphical user interface displayed at the screen. Alternatively, the camera unit may be activated by a predefined movement of the hand held device.

Detecting the fingernail may comprise detecting the characteristics of the fingernail. Detecting the characteristics of the fingernail may comprise detecting the cuticle shape, or alternatively, detecting the contrast between the cuticle and the area of the finger surrounding the cuticle such as at least one of the nail plate, nail bed and nail fold. Detecting the fingernail in such a way has the advantage that it is independent from different lengths of the fingernail. In alternative embodiments, the device may detect a portion of the finger, the distal phalange or the fingertip.

The fingernail may be detected in the visible light range or via an optical link. In some embodiments the hand held device may not detect the fingernail using radio frequency signals or a radio frequency link. In some embodiments only the hand or the fingernail but not the body of the user is detected via the camera unit.

The user may position the hand held device so that the fingernail is in the field of view of the camera unit. The user may position the device with one hand while making the finger movement with the other hand. Alternatively, the hand held device may be positioned or arranged on a holder, a support or a stand so that the user is relieved from holding the device.

The camera unit may detect the fingernail through incoming visible light rays and convert these optical signals into electrical (e.g., digital) signals. The electrical information is forwarded to a processing unit and the processing unit displays the fingernail via a graphical user interface on the display or screen of the hand held device. When the fingernail is moved in front of the hand held device the visible image of the fingernail on the screen of the device is moved too so that the screen always displays the fingernail in real time (or near real time). At this time the hand held device does not record or store the fingernail movement; it just displays the fingernail and its movement on the screen. In other embodiments, instead of displaying the fingernail a mouse type pointer may be displayed moving over a text document as described later.

Detecting the fingernail may be performed after the user has opened a text file or text document such as a pdf document, a word document, or an excel document. Alternatively, the fingernail is detected after the user has opened or selected a text box for writing a text message using a text messaging service through the graphical user interface of the display. In yet another embodiment, selecting a text generating application may provide a graphical user interface so that the user can prepare a document using the virtual handwriting process and transform this document later into a pdf format, a word format or an excel format.

The document or file to be opened may be loaded into the processing unit from the memory unit and displayed in a graphical user interface of the screen of the hand held device. In an embodiment, the fingernail may visibly overlay the document so that the fingernail can be seen moving over and around the document. The fingernail or the mouse type pointer may move to a specific word, sentence or paragraph to start editing the document. For example, the fingernail or the mouse type pointer may move a cursor, select or highlight certain text blocks, paragraphs, pictures, words or graphics in the document.

The graphical user interface displayed in the screen may include a start/stop icon or button. The start/stop icon may display start when recording is not yet started and may display stop when recording has started. In some embodiments not only a start/stop icon or button is displayed but also a pause/continue icon or button. Similar to the above description to the start/stop icon the pause/continue icon may display continue when recording is paused and may display pause when recording has continued. The icon(s) may be located at the corner(s) of the user interface. For example, for a left handed person the icon(s) may be located on the left corner(s) of the user interface (e.g., display) and for a right handed person the icon(s) may be located on the right corner(s) of the user interface (e.g., display).

In some embodiments the hand held device does not comprise a dedicated text entry area such as a dedicated writing pad area or dedicated graphical user interface to write thereon.

At decision block 133 the process determines whether the user has started virtual handwriting (e.g., activated or selecting a start function). The user may start the handwriting by selecting or pressing the start button or, alternatively, the continue button displayed on the user interface on the screen of the hand held device. For example, after the user has moved the cursor of a text document to a specific position of the document and selected the start button the user can start real time editing the text by virtually handwriting the desired indicia (e.g., letters) on a surface in front of the camera unit. At this point the process may start recording the gestured indicia.

In other embodiments the process may determine the beginning of the recording of the indicia by identifying the fingernail. For example, the device could start recording the indicia when the user moves the finger in front of camera, e.g., when the device detects the fingernail.

In alternative embodiments the user can start recording the indicia by showing another finger. For example, the user may typically gesture the indicia with a first finger, e.g., the index finger. If he wants to commence the recording process he may show a second finger, e.g., the thumb, before start virtually writing with the index finger. In yet other embodiments, the user may provide a predefined gestured in front of the camera to start the recording process. For example, the user may double tap or make a swiping gesture in front of the camera unit.

If the user has started virtually gesturing indicia the process moves to process block 136 in order to track the fingernail. If the user has not started drawing indicia, the decision block 133 repeatedly checks whether the user has started the virtual handwriting.

Upon starting the virtual handwriting in front of the camera unit, the fingernail is tracked according to processing block 136. The processing block 136 tracks the fingernail and identifies the beginning and the end of the indicia such as a character, a letter or a number. The indicia is transformed into a digital indicia by the processing unit. In some embodiments the processing unit may include the CMOS logic at the image sensor.

At decision block 139 the process determines whether the virtual writing of the indicia is completed (or whether a user activated or selected a stop function). The user may stop the handwriting by selecting or pressing the stop button or, alternatively, the pause button displayed on the user interface on the screen of the hand held device.

In some embodiments the process may know (e.g., has stored) the number of pixels for each indicia. Accordingly, the process may determine the number of pixels or pixel range covered by the gesture when the user lifts the finger and moves the finger outside the pixel range. This may be a learned behavior since different users may draw different sized indicia.

In yet alternative embodiments, the user may stop the recording process for the indicia by showing the second finger again (or by showing a recognized third finger), or by swiping or double tapping again in front of the camera.

If the user has not stopped drawing the indicia, the decision block 139 repeatedly checks whether the fingernail is still tracked or whether the virtual handwriting of the indicia is completed.

At processing block 142 a handwriting recognition algorithm runs over the optically received and converted digital intake of the finger gesture. The handwriting recognition algorithm operating at the processing unit may associate the finger gesture(s) with an indicia and then compares the indicia with a stored indicia at decision block 143 (the stored indicia is the trained indicia from the earlier process step 120). This may be done after the user has finished the virtual handwriting gesture(s). The handwriting recognition algorithm may provide immunity to inconsistencies in fingernail speeds while the user virtually writes the indicia. The handwriting recognition algorithm may also provide immunity to minor variations of the virtually drawn indicia.

In some embodiments the handwriting recognition algorithm may be dynamic time warping (DTW). DTW may be an algorithm for measuring similarities between two temporal sequences which may vary in time or speed. For instance, similarities in writing patterns, characters, letters or numbers could be detected using DTW. Even if the user was writing the characters, letters or numbers with different speeds or different sizes the algorism will recognize these indicia as long as the pattern of these indicia are similar with those previously stored.

At decision block 143, a determination is made by the decision unit whether the drawn indicia written by virtual finger gesture and converted into a digital indicia matches a stored indicia in the library of the memory unit. Decision block 143 compares similarities of the captured indicia with the known (stored) indicia. If the processing unit recognizes the indicia (e.g., similar form of the digital indicia) a return match is displayed by the graphical user interface of the screen at processing block 145. If the processing unit does not recognize the indicia, because the compared indicia are too different, the process advances to processing block 150 and an error message is displayed at the graphical user interface of the display.

The process then advances to decision block 160. At this stage a determination is made whether the user wants to add the unrecognized indicia to the library in the memory unit or not. If the user wants to add the indicia to the library because it is a new and useful indicia an indicia with which the hand held device has not been previously trained) then the process advances to the processing block 145 via the processing block 170. The indicia is added to the library and displayed at the graphical user interface. If a text document is open the document may be edited with the new indicia.

If the user does not want to add the identified indicia to the library (because a stored indicia was not properly virtually drawn) the processing advances to processing block 130 and the process continues from this block anew.

When the process returns a match at block 145 the user may start writing the next indicia via decision block 133 in some embodiments. The next indicia is displayed via the process steps 133-145. If there are enough indicia, the process may prompt the user at the graphical user with a predicted word, phrase or indicia sequence at processing block 148 before the editing is finalized and the process advances to the end at block 180. The user may decide whether or not to accept the predicted word, phrase or character sequence. The process may predict the word, phrase or character sequence based on recognizing a recognized indicia, sequence of indicia, word or phrase portion. If the user does not want to accept the proposed indicia sequence or word the prompted word or sequence may be skipped. Processing then proceeds to clock 180 where the process ends.

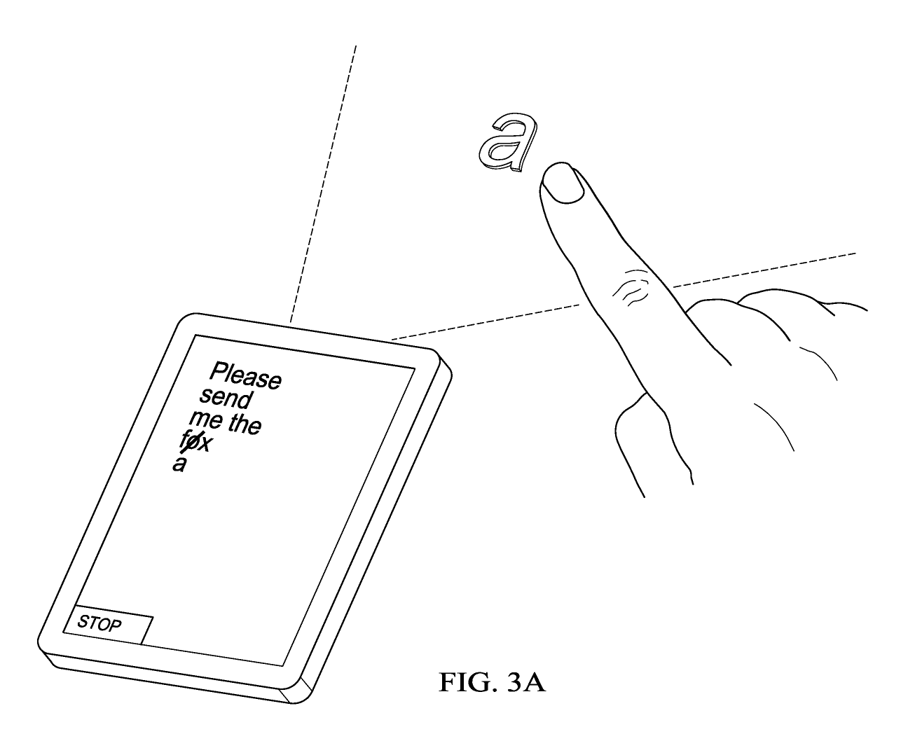

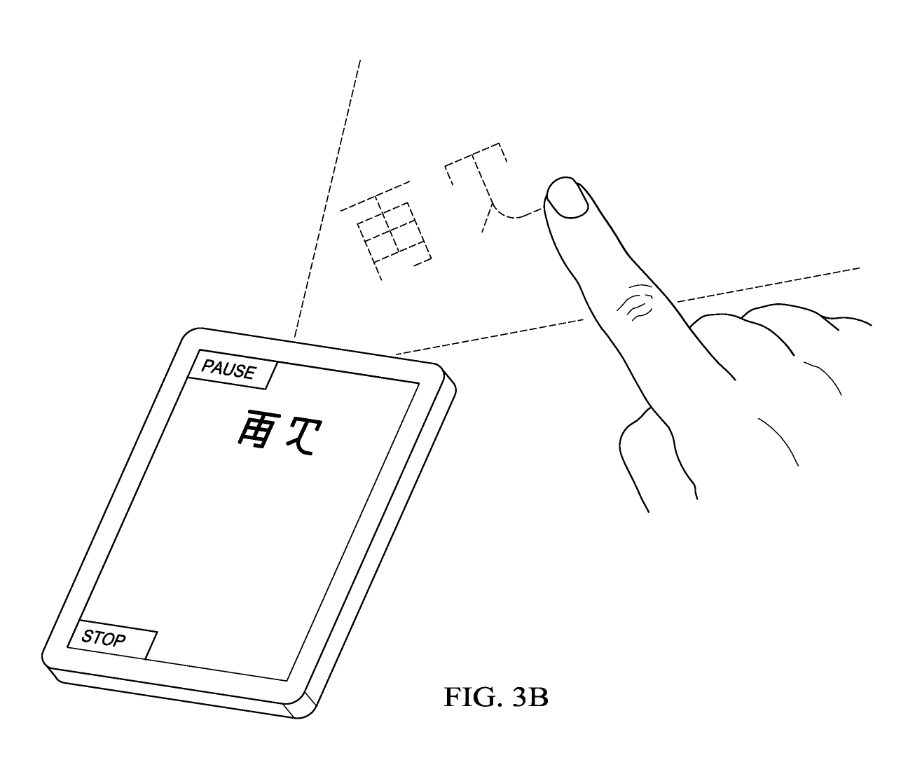

FIG. 3a shows an embodiment of editing an English text document such as a word document or a pdf document via the optical gesture recognition process. Of course a real implementation would not show the “o” crossed out and an “a” written below it but rather replace the “o” with the “a.” No “o” would be seen after editing. Here it is only done for clarification purposes. FIG. 3b shows an embodiment of writing a text message using Chinese characters via the optical gesture recognition process. The user can edit a text document or write a text message using different letters and characters without switching keyboards at the hand held device.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for recognizing virtual handwriting, the method comprising:
optically capturing a finger gesture by a camera unit of a computing device;
transforming the finger gesture into a digital indicia by a processing unit of the computing device;
comparing the digital indicia with a stored indicia by the processing unit, wherein the stored indicia is stored in a memory unit of the computing device; and
displaying the digital indicia on a display of the computing device.

2. The method according to claim 1, wherein capturing the finger gesture comprises capturing a distal phalange gesture.

3. The method according to claim 2, wherein the distal phalange comprises a fingernail.

4. The method according to claim 3, wherein the fingernail comprises a shape of a cuticle.

5. The method according to claim 3, wherein the fingernail comprises a cuticle shape and a contrast between the cuticle shape and at least one of a nail plate, a nail bed and a nail fold.

6. The method according to claim 1, wherein optically capturing the finger gesture by the camera unit comprises tracking a movement of the finger performed on a surface.

7. The method according to claim 1, further comprising loading a document to be edited from the memory unit into the processing unit, and editing the document with the digital indicia.

8. The method according to claim 1, further comprising activating the camera unit by selecting a button of an I/O unit of the computing device or by selecting a button in a graphical interface of the display.

9. The method according to claim 1, wherein capturing the finger gesture comprises selecting a start function, tracking a finger gesture and selecting a stop function.

10. The method according to claim 1, wherein capturing the finger gesture comprises:
selecting a start button on a graphical user interface of the display;
tracking the finger moving over a surface in front of the camera unit;
selecting a pause button on the graphical user interface of the display;
selecting a continue button on the graphical user interface of the display;
tracking the finger over the surface in front of the camera unit; and
selecting a stop button on the graphical user interface of the display.

11. The method according to claim 1, further comprising storing indicia in the memory unit, the indicia being defined by a user.

12. The method according to claim 1, wherein the camera unit is integrated in the computing device.

13. The method according to claim 1, further comprising arranging the computing device on a holder, a support or stand before optically detecting the finger by a user.

14. A computing device comprising:
a processing unit;
a computer-readable storage medium storing a program to be executed by the processing unit, the program including instructions for:
optically receiving an indicia gestured by a finger of a user in front of a camera unit of the computing device;
transforming the optical indicia into a digital indicia;
comparing the digital indicia to a stored digital indicia; and
displaying the digital indicia when the digital indicia matches the stored indicia.

15. The device according to claim 14, further comprising uploading a text file before optically receiving the indicia and editing the text file with the displayed digital indicia.

16. The device according to claim 14, further comprising displaying an error message when the digital indicia does not match the stored indicia.

17. The device according to claim 14, wherein the stored digital indicia are user defined indicia, and wherein the user defined indicia are defined by virtual handwriting gestures.

18. A computing device comprising:
an camera unit configured to receive optical indicia data provided by a virtual handwriting gesture of a user;
a processing unit operatively connected to the camera unit, the processing unit configured to transform the optical indicia data into digital indicia data and compare the digital indicia data with stored digital indicia data, wherein the stored digital indicia data are stored in a memory unit, the memory unit operatively connected to the processing unit; and
a display operatively connected to the processing unit, the display configured to display the digital indicia data when the digital indicia data match the stored indicia data.

19. The computing device according to claim 18, further comprising an I/O unit, the I/O unit operatively connected to the processing unit, wherein the I/O unit is key pad with physical buttons located on the computing device.

20. The computing device according to claim 18, further comprising an I/O unit, the I/O unit operatively connected to the processing unit, wherein the I/O unit is graphical user interface comprising a key board.

21. A non-transitory computer readable medium that stores instructions to be executed by a computing device, the instructions comprising:
optically capturing a finger gesture by a camera unit of the computing device;
transforming the finger gesture into a digital indicia by a processing unit of the computing device;
comparing the digital indicia with a stored indicia by the processing unit, wherein the stored indicia is stored in a memory unit of the computing device; and
displaying the digital indicia on a display of the computing device.
